(19) United States
(12) Patent Application Publication
(10) Pub. No.: US 2016/0117961 A1
(43) Pub. Date: Apr. 28, 2016

(54) LIQUID ORNAMENT ASSEMBLY

(71) Applicant: Jui-An TSAI, Taoyuan City (TW)

(72) Inventor: Jui-An TSAI, Taoyuan City (TW)

(21) Appl. No.: 14/525,893

(22) Filed: Oct. 28, 2014

(51) Int. Cl. G09F 19/02; G09F 13/00

(52) U.S. Cl. CPC G09F 19/02; G09F 13/00

(57) ABSTRACT

A liquid ornament is revealed. The liquid ornament includes a closed container and a film sheet. A liquid ornament is received in the closed container and is displayed. The liquid ornament consists of combinations of at least two of a first liquid, a second liquid and at least one ornament. The film sheet is formed by a first end surface and a second surface opposite to the first end surface. The first end surface is attached to a connection part of the closed container while the second end surface is attached to a surface of a solid object.

### BACKGROUND OF THE INVENTION

The present invention relates to a liquid ornament assembly, especially to a liquid ornament assembly able to be attached to a surface of a solid object.

A conventional liquid ornament assembly mainly includes a transparent container body with liquid and ornaments therein. Due mature of the manufacturing techniques and reduced production cost, the liquid ornament assembly has a plurality of use patterns. For example, the liquid ornament assembly is connected to common objects such as a hanging ornament, a mouse, a portable electronic, a calculator, a music box, a radio, a cup, a cushion, a lotion bottle or a watch etc. for users to select and use.

According to different structures and inner designs, the liquid ornament assembly has different decorative effect. The followings are various types of liquid ornament assembly. (1) Refer to Chinese patent Publication No. CN2920128Y, a condiment bottle with dynamic effect of glitter lamp is revealed. Optical reflection and dynamic light effect are expressed by colorful glitter powder floated in the liquid inside the container. (2) Refer to Chinese patent Publication No. CN2920128Y, dynamic floating effect is achieved by bubbles floating in gaps among multiple layers of transparent plates. (3) Refer to Chinese patent Publication No. CN94220996.6, a mountain range is shown by glass beads or plastic grits rising or sinking within two spaces. (4) Refer to Chinese patent Publication No. CN2268183Y, a decorative effect is provided by a cloudy liquid in a container being driven to flow. (5) Refer to Chinese patent Publication No. CN2375858Y, a dynamic effect is achieved by a floating object in a double liquid system or a magma-type hourglass. (6) Refer to Chinese patent Publication No. CN95227756.5, a dynamic, wave-like effect is achieved by liquids with different color swinging back and forth in a container. (7) Refer to Chinese patent Publication No. CN2492917Y, small particles are driven by liquid to pass through a volcano-shaped nozzle for imitating volcanic eruption and creating dynamic effect. (8) Refer to Chinese patent Publication No. CN3028009, a liquid hourglass in a rotating disc shows color changes. (9) Refer to Chinese patent Publication No. CN92229947.1, a dynamic effect like weaving sea, landscape scene, thin water growing and flowing, volcanic eruption or sand storm is achieved by dropping liquid into a corrugated surface of a plate. (10) Refer to Chinese patent Publication No. CN92230246.4, a dynamic effect like sand picture is achieved by using an hourglass passing through channels preset on a panel in a liquid container. (11) Refer to Chinese patent Publication No. CN91227972.9, a display effect with slightly transitions is achieved by a liquid-type display panel with slightly transitions. (12) Refer to Chinese patent Publication No. CN92201177.X, Two liquids with different density are used the liquid with higher density is dropped to a water wheel so that paddles of the water wheel are driven to rotate.

Moreover, when a user intends to attach a conventional liquid ornament to a solid object, the most common way is to fix the liquid ornament on a slot arranged at the solid object. Thus a slot with a certain width is preset on the solid object for mounting the liquid ornament. Or the liquid ornament is first connected to a frame and then is fixed/fastened on the surface of the solid object by the frame. However, the connection between the liquid ornament and the solid object is monotonous. Even there is a special design on the connection, the design is lack of interest, assembly convenience and practicability. The design can't stimulate the consumer to purchase. When the size or the shape of the solid object is changed, the size or shape of the liquid ornament should also be changed. Thus the production cost of the liquid ornament is increased and the use efficiency of the liquid ornament is lower.

### SUMMARY OF THE INVENTION

Therefore it is a primary object of the present invention to provide a liquid ornament assembly that features on higher interest, convenience, practicability, lower cost and easy assembly.

In order to achieve the above object, a liquid ornament assembly of the present invention includes a closed container and a film sheet. The closed container consists of a display part on one side and a connection part on the opposite site. A first chamber is disposed in the closed container and is adjacent to the display part. A liquid ornament is received in the first chamber. The liquid ornament includes combinations of at least two of the following items, a first liquid, a second liquid and at least one ornament. The liquid ornament is displayed through the display part. The film sheet includes a first end surface attached to the connection part of the closed container and a second end surface that is opposite to the first end surface and attached to a surface of a solid object.

According to the structure mentioned above, the first end surface of the film sheet is directly attached to the connection part of the closed container while the second end surface of the film sheet is directly connected to the surface of the solid object. The interest, convenience and practicability of the liquid ornament assembly connected to the solid object are improved. Thus the liquid ornament assembly has a better design.

### BRIEF DESCRIPTION OF THE DRAWINGS

FIG. 1 is a perspective view of an embodiment of a liquid ornament assembly according to the present invention;

FIG. 2 is another perspective view of the embodiment in FIG. 1 according to the present invention;

FIG. 3 is an explosive view of the embodiment in FIG. 1 according to the present invention;

FIG. 4 is a schematic view showing an embodiment of a liquid ornament in use according to the present invention;

FIG. 5 is a perspective view of another embodiment of a liquid ornament assembly according to the present invention;

FIG. 6 is a perspective view of another embodiment of a liquid ornament assembly according to the present invention;

FIG. 7 is a perspective view of a further embodiment of a liquid ornament assembly according to the present invention;

FIG. 8 is a perspective view of a further embodiment of a liquid ornament assembly according to the present invention;

FIG. 9 is a partial explosive view of a further embodiment of a liquid ornament assembly according to the present invention;

FIG. 10 is a front view of a further embodiment of a liquid ornament assembly with a hollow square frame according to the present invention;

FIG. 11 is a right side view of the embodiment in FIG. 10 according to the present invention;

FIG. 12 is a schematic drawing showing the embodiment in FIG. 10 in use according to the present invention;

FIG. 13 is another schematic drawing showing the embodiment in FIG. 10 in use according to the present invention;

FIG. 14 is a schematic drawing showing the embodiment in FIG. 10 with a C-shaped frame according to the present invention;

FIG. 15 is a front view of a further embodiment of a liquid ornament assembly according to the present invention;

FIG. 16 is a right side cross-sectional view of the embodiment in FIG. 15 according to the present invention.

### DETAILED DESCRIPTION OF THE PREFFERED EMBODIMENTS

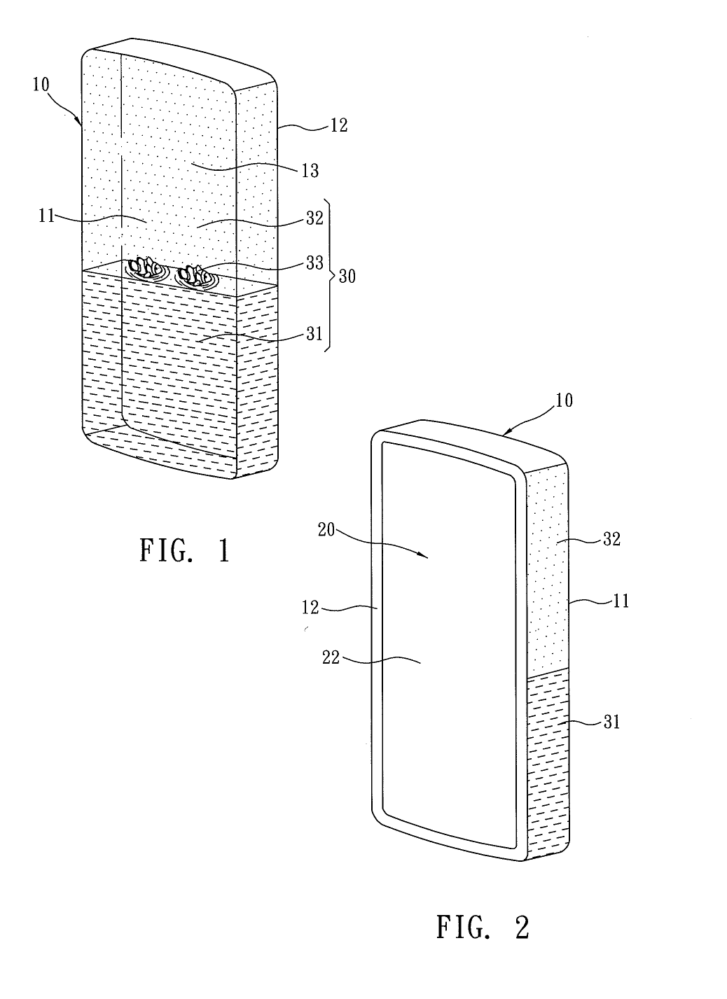

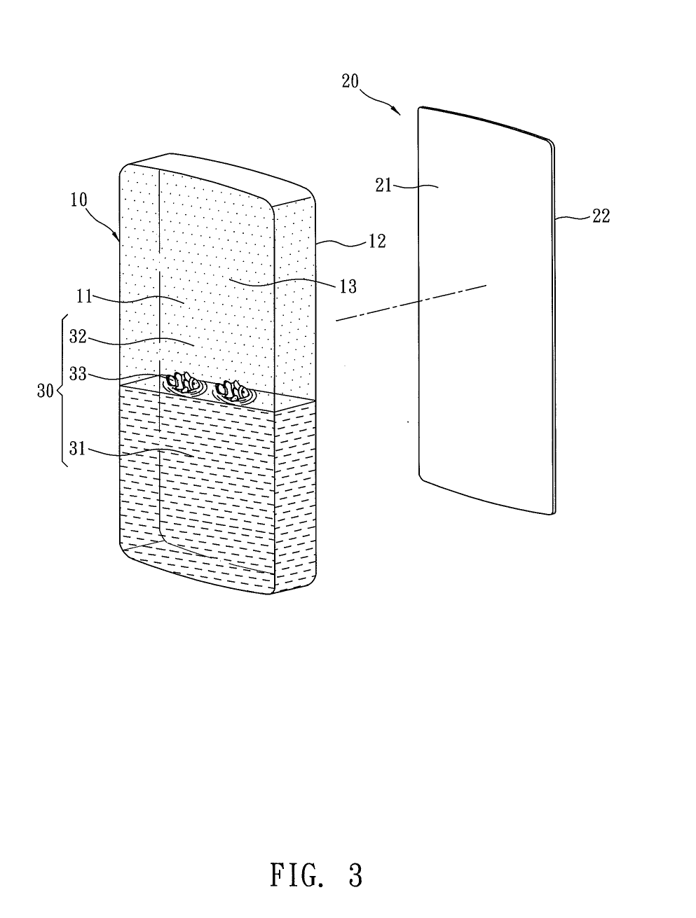

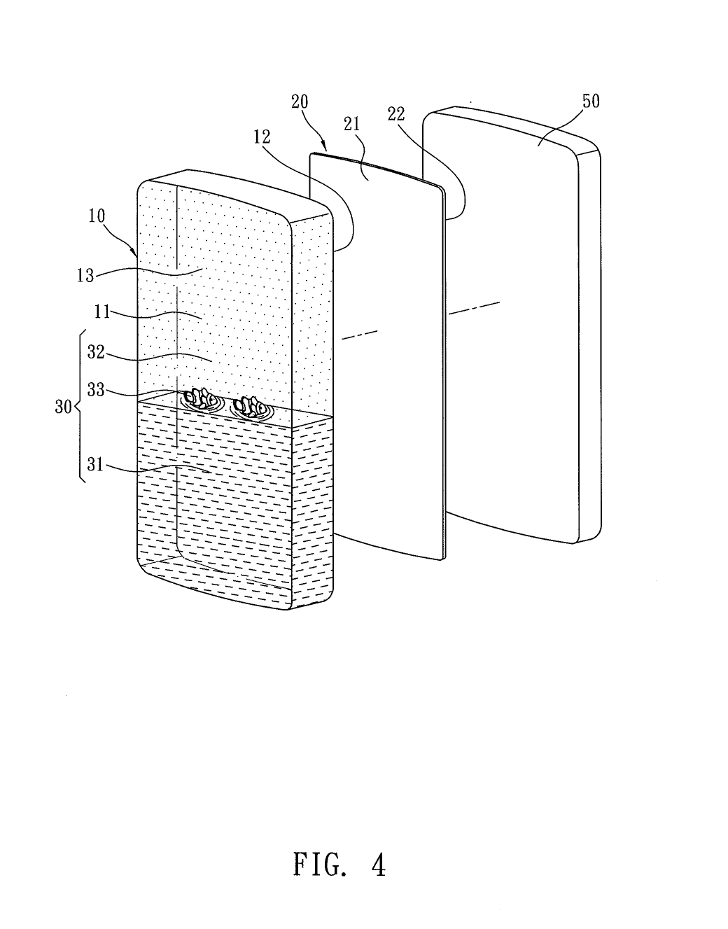

Refer from FIG. 1 to FIG. 4, a liquid ornament assembly of the present invention includes a closed container 10 and a film sheet 20.

The closed container 10 is a transparent container whose appearance including length, width, thickness, outer diameter, etc. can be designed into various types according to user's requirements. The closed container 10 includes a display part 11 on one side and a connection part 12 on the opposite site. A first chamber 13 is disposed in the closed container 10 and is adjacent to the display part 11. A liquid ornament 30 is received in the first chamber 13. The liquid ornament 30 includes combinations of at least two of the following items, a first liquid 31, a second liquid 32 and at least one ornament 33. The first liquid 31 and the second liquid 32 have different density. Thus the ornament 33 is moveable (such as floated or suspended) or fixed in the first liquid 31 and/or the second liquid 32. The liquid ornament 30 is displayed through the display part 11. Moreover, the connection part 12 is located on a part of surface of or whole surface of the opposite side of the display part 11.

The film sheet 20 consists of a first end surface 21 and a second end surface 22 opposite to the first end surface 21. The first end surface 21 is attached to the connection part 12 of the closed container 10 while the second end surface 22 is attached to a surface of a solid object 50. Thus the film sheet 20 and the closed container 10 are integrated into one part and attached to the surface of the solid object 50. The solid object 50 can be a notebook, a wallet, a cup, a mobile phone, a mobile phone case, a computer, a hat, a piece of clothes, a mobile phone holder, a computer stand, etc. Moreover, the film sheet 20 can be attached to a part of or the whole connection part 12.

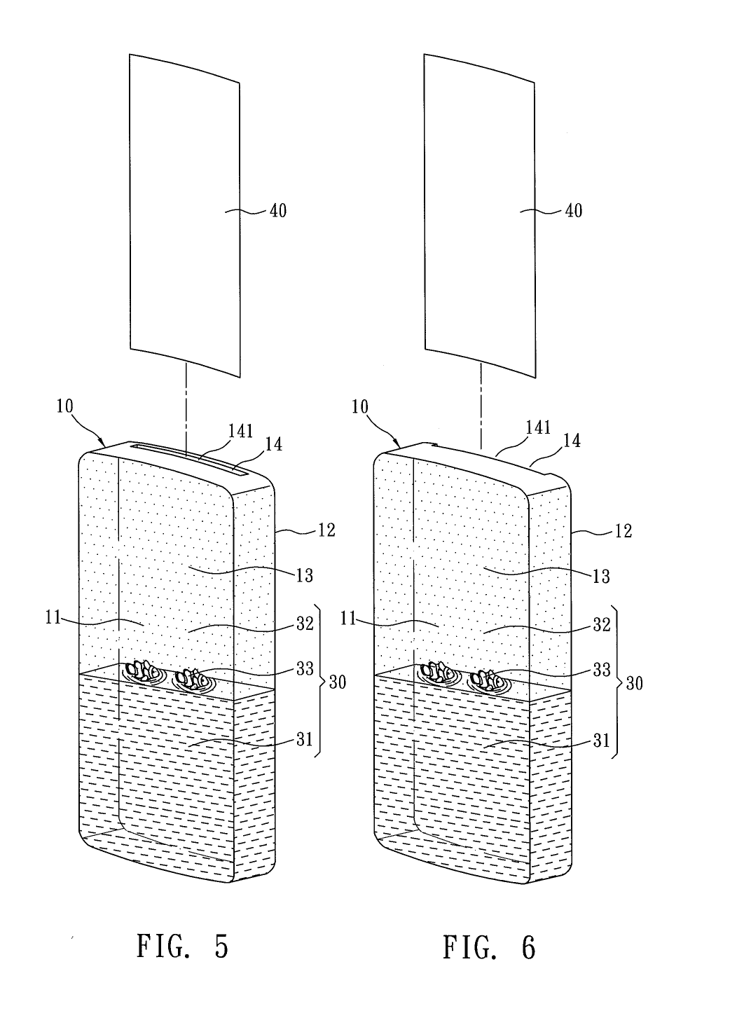

Refer to FIG. 5 and FIG. 6, another embodiment of the present invention is disclosed. The difference between this embodiment and the above one is in that the closed container 10 is arranged with a second chamber 14 that is located between the first chamber 13 and the connection part 12 and adjacent the first chamber 13. One side of the second chamber 14 is mounted with an opening 141 communicating with the external environment. The decorative sheet 40 is passed through the opening 141 to be set into the second chamber 14. The decorative sheet 40 can be used as a background decoration of the first chamber 13 to improve the aesthetic sense. The second chamber 14 can be disposed inside the closed container 10, as shown in FIG. 5 or on an outer surface of the closed container 10 and formed by the outer surface of the connection part 12 dented inward, as shown in FIG. 6.

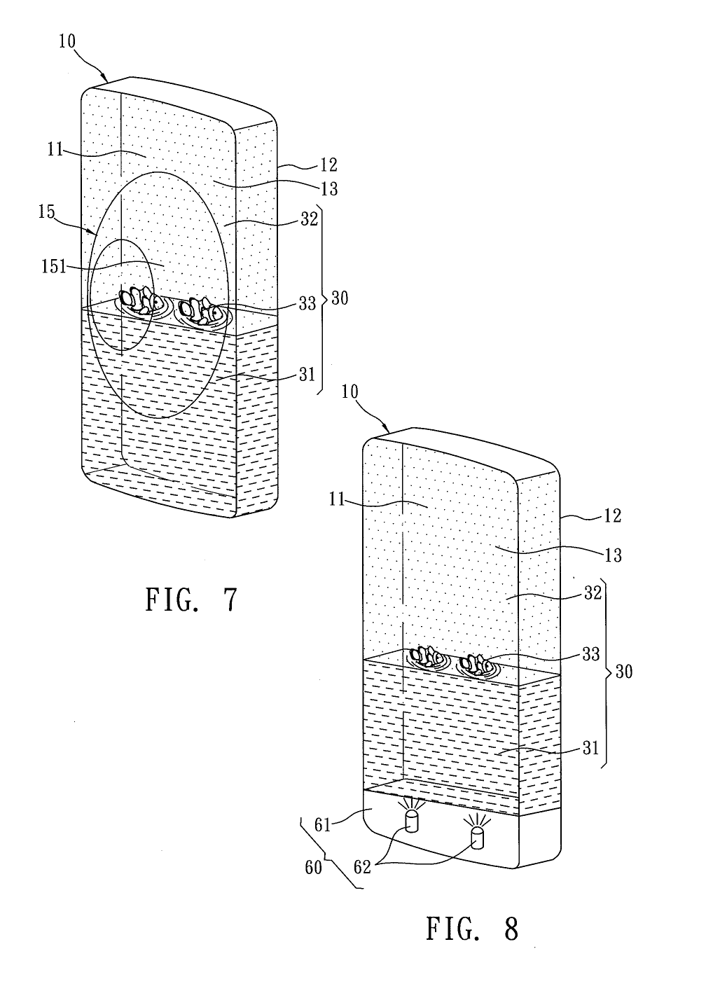

Refer to FIG. 7, a further embodiment of a liquid ornament according to the present invention is revealed. The difference between this embodiment and the first embodiment mentioned above is in that one side of the closed container 10 with the display part 11 is further arranged with a convex portion 15 having magnification. Thus the liquid ornament 30 in the closed container 10 appears bigger due to the convex portion 15. In this embodiment, the convex portion 15 is a convex curved surface 151 projecting outward a preset distance. Moreover, the convex portion 15 is located at a part of or the whole surface of the closed container 10 disposed with the display part 11.

Refer to FIG. 8, a further embodiment of a liquid ornament according to the present invention is revealed. The difference between this embodiment and the first embodiment mentioned above is in that the bottom of the closed container 10 is connected to a lighting unit 60. The lighting unit 60 consists of a housing 61 and at least one lighting member 62. The housing 61 is fixed on the bottom of the closed container 10 and the lighting members 62 are mounted in the housing 61. The lighting member 62 can be light emitting diode (LED). The light from the lighting members 62 is projected to the first chamber 13 and/or the second chamber 14 of the closed container 10. Thus after the liquid ornament 30 in the first chamber 13 and/or the decorative sheet 40 in the second chamber 14 being illuminated by the light, the images change and the interest is enhanced.

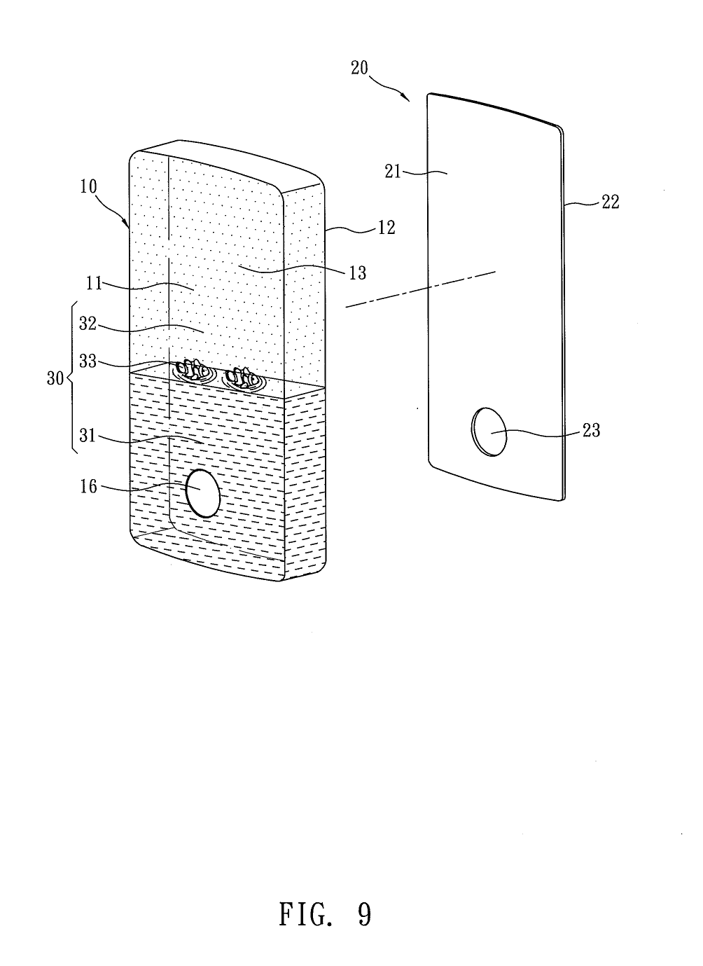

Refer to FIG. 9, a further embodiment of a liquid ornament according to the present invention is disclosed. The difference between this embodiment and the first embodiment mentioned above is in that a through hole 16 is horizontally penetrating the closed container 10 and disposed between the display part 11 and the connection part 12. The through hole 16 is corresponding to an area on the surface of the solid object 50 arranged with graphs or marks (such as brand logos). The film sheet 20 is also mounted with an opening 23 corresponding to through hole 16 so as to prevent the through hole 16 from being shielded. For example, when the solid object 50 is a mobile phone, the closed container 10 is connected to one side of the mobile phone 50, opposite to the side of the mobile phone 50 disposed with the display part 11. Now the through hole 16 of the closed container 10 and the opening 23 of the film sheet 20 are corresponding to and aligned with the graph on the mobile phone 50. Thus the graph can be shown. In this embodiment, the graph or logo on the solid object (such as mobile phone) 50 can still be displayed besides dynamic effect provided by the liquid ornament after the liquid ornament being connected to the solid object 50 (such as mobile phone). Thereby a double aesthetic sensation is created and the interest is enhanced.

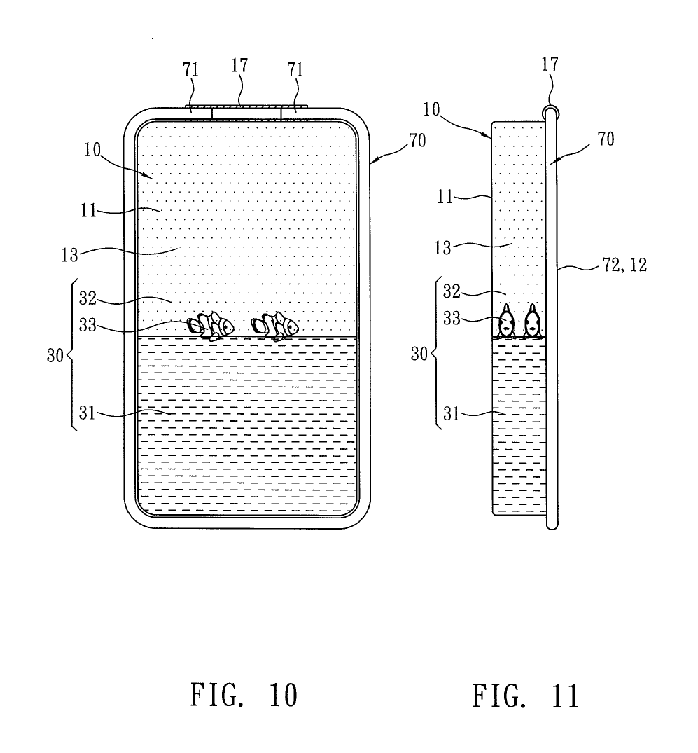

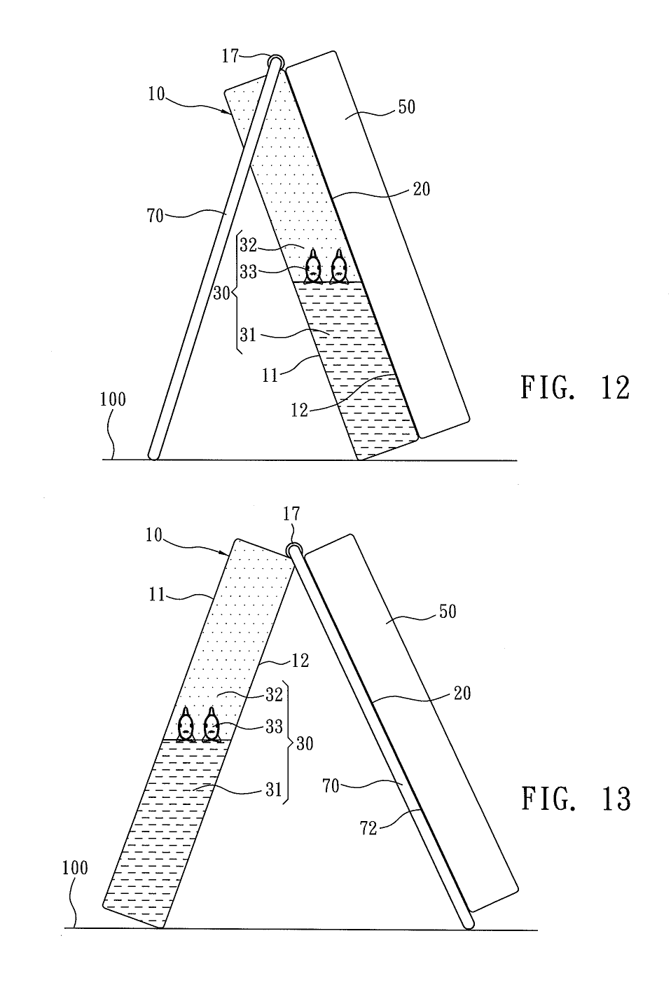

Refer from FIG. 10 to FIG. 14, a further embodiment of a liquid ornament according to the present invention is disclosed. The difference between this embodiment and the first embodiment mentioned above is in that the closed container 10 further includes a frame 70. The frame 70 is set on one side of the closed container 10. A pivot part 17 is disposed on one side of the closed container 10 while the frame 70 includes a pivoted part 71 corresponding to and pivotally connected to the pivot part 17 of the closed container 10. After the closed container 10 and the frame 70 pivotally connected to each other correspondingly by the pivot part 17 and the pivoted part 71 connected to each other, the frame 70 can be rotated in relation to the closed container 10 to be in an opened state or a closed state. Moreover, the shape of the frame 70 can be a hollow square as shown in FIG. 10 or C-shaped as shown in FIG. 14. In this embodiment, when the frame 70 is rotated in relative to the closed container 10 to be in the opened state, the closed container 10 is standing over a flat surface 100 (such as a desk surface). Thus the solid object 50 (such as mobile phone) connected to the closed container 10 is also standing vertically along with the closed container 10, as shown in FIG. 12. Refer to FIG. 13, the frame 70 includes a connection portion 72 at the same surface of the connection part 12 of the closed container 10. Thus the first end surface 21 of the film sheet 20 can be attached to the connection portion 72 of the frame 70 and the connection portion 72 of the frame 70 can be used as the connection part 12 of the closed container 10. Therefore the solid object 50 (such as mobile phone) connected to the frame 70 can be standing over the flat surface 100 (such as the desk surface) along with the frame 70 rotated to the opened state.

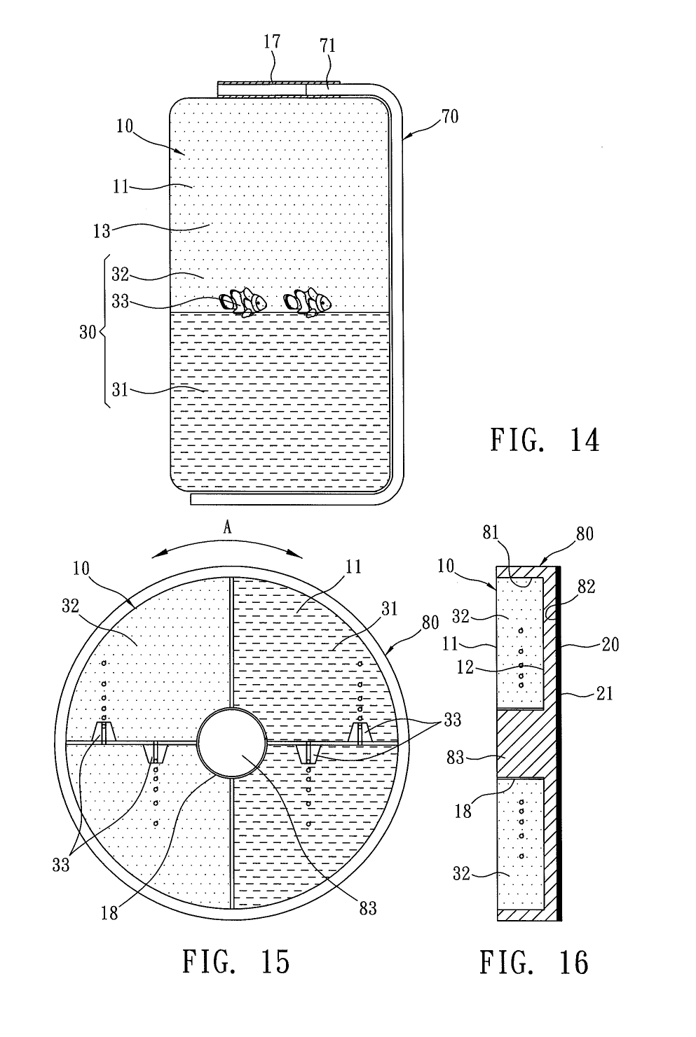

Refer to FIG. 15 and FIG. 16, a further embodiment of a liquid ornament according to the present invention is disclosed. The difference between this embodiment and the first embodiment mentioned above is in that the closed container 10 further includes a loading base 80. The closed container 10 is arranged over the loading base 80 and able to rotate. One side of the loading base 80 is disposed with a receiving slot 81 for mounting the closed container 10 while the other side (the opposite side) is set with a connection part 82 being connected to the first end surface 21 of the film sheet 20. The connection part 82 of the loading base 80 is used like the connection part 12 of the closed container 10. A shaft 83 is projecting from the bottom surface of the receiving slot 81 while a shaft base 18 correspondingly and moveably connected to the shaft 83 is arranged at the closed container 10. After the loading base 80 being connected to the closed container 10 by the shaft 83 assembled with the shaft base 18, the closed container 10 can be rotated around the shaft 83 in relative to the loading base 80, as the arrow A indicated in FIG. 15. The shaft base 18 of the closed container 10 can be formed by an axial hole penetrating the closed container 10 or an axial hole not penetrating the closed container 10 (not shown in figure). Moreover, the ornament 33 of the liquid ornament 30 is formed by a plurality of nozzles being fixed. The first liquid 31 and the second liquid 32 are of different colors. The first liquid 31 and the second liquid 32 with different colors pass the nozzle respectively so as to for jet and flow with dynamic patterns. In this embodiment, the connection part 12 of the closed container 10 is facing and mounted to a bottom surface of the receiving slot 81 of the loading base 80 while the display part 11 of the closed container 10 is facing outward so as to show the liquid ornament 30. Furthermore, the shaft 83 of the loading base 80 is fitted over the shaft base 18 of the closed container 10. When the closed container 10 is rotated in relation to the loading base 80, the liquid ornament 30 in the closed container 10 has rotational and dynamic expression.

The liquid ornament 30 of the present invention can have different decorative patterns achieved by techniques available now (such as techniques revealed in Chinese utility patent mentioned above). (1) The liquid ornament 30 includes a glitter powder ornament. The optical reflection and dynamic light effects are expressed by combinations of transparent liquid, colorful glitter powder and LED lights. (2) The ornament 33 is a floating ornament with air bubbles. A dynamic floating effect is achieved by combination of different colored liquid, transparent plates and rising air bubbles. (3) The liquid ornament 30 is a sand picture ornament. A mountain range is shown by glass beads or plastic grits rising or sinking within two spaces. (4) The liquid ornament 30 includes a cloudy liquid ornament. The cloudy liquid is driven to flow and have dynamic decorative effect. (5) The liquid ornament 30 is a floating object in a double liquid system or a liquid hourglass. A dynamic effect is achieved by the floating object in the double liquid system or a magma-type hourglass. (6) The liquid ornament 30 is a swinging ornament in a double liquid system. A dynamic, wave-like effect is achieved by liquids with different color swinging back and forth. (7) The liquid ornament 30 includes an ornament ejected by liquid. Small particles are driven by liquid to pass through a nozzle for imitating volcanic eruption. (8) The liquid ornament 30 is a liquid ornament that changes color during rotation. A box with liquid therein that changes color during rotation is revealed. (9) The liquid ornament 30 includes a hourglass ornament. By dropping liquid into a corrugated surface of a plate, a dynamic effect like weaving sea, landscape scene, thin water growing and flowing, volcanic eruption or sand storm is achieved is achieved. (10) The liquid ornament 30 includes a hourglass ornament. A dynamic effect like sand picture is achieved by using a hourglass passing through channels preset on a panel in a liquid container. (11) The liquid ornament 30 includes a liquid-type ornament with slightly transitions. A display effect with slightly transitions is achieved by a liquid-type display panel with slightly transitions. (12) The liquid ornament 30 includes a water wheel ornament. Two liquids with different density are used the liquid with higher density is dropped to a water wheel so that paddles of the water wheel are driven to rotate.

In summary, the liquid ornament o the present invention is formed by a closed container 10 integrated with a film sheet 20. The structure of the liquid ornament is simple. Thus no additional processing and assembly are required. The production cost is reduced. Moreover, the closed container 10 can be fixed on a solid object 50 more easily and conveniently. Thus the interest, convenience and use efficiency of the liquid ornament are improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A liquid ornament assembly comprising:
a closed container having a display part on one side and a connection part on an opposite side; a first chamber is disposed in the closed container and is adjacent to the display part; a liquid ornament is received in the first chamber and the liquid ornament includes combinations of at least two of the following a first liquid, a second liquid and at least one ornament; the liquid ornament being displayed through the display part; and
a film sheet that includes a first end surface attached to the connection part of the closed container and a second end surface that is opposite to the first end surface and attached to a surface of a solid object; the film sheet being attached to a part of or the whole connection part,
wherein the solid object is selected from the group consisting of a notebook, a mobile phone, a mobile phone case, a mobile phone holder.

2. The device as claimed in claim 1, wherein the closed container is arranged with a second chamber that is located between the first chamber and the connection part and used for receiving a decorative sheet; one side of the second chamber is mounted with an opening communicating with an external environment so that the decorative sheet is able to be passed through the opening and mounted into the second chamber.

3. The device as claimed in claim 2, wherein the second chamber is set inside the closed container.

4. The device as claimed in claim 2, wherein the second chamber is arranged at an outer surface of the closed container and formed by the outer surface of the connection part dented inward.

5. The device as claimed in claim 1, wherein the first liquid and the second liquid have different density.

6. The device as claimed in claim 1, wherein the closed container is arranged with a through hole; the through hole is horizontally penetrating the closed container and located between the display part and the connection part.

7. The device as claimed in claim 1, wherein the closed container further includes a frame set on one side of the closed container; a pivot part is disposed on one side of the closed container while the frame includes a pivoted part corresponding to and pivotally connected to the pivot part of the closed container; after the closed container and the frame pivotally connected to each other correspondingly by the pivot part and the pivoted part connected to each other, the frame is rotated in relation to the closed container to be in an opened state or a closed state.

8. The device as claimed in claim 7, wherein the frame is a hollow square or C-shaped.

9. The device as claimed in claim 7, wherein the frame includes a connection portion which is at the same surface of the connection part of the closed container; the first end surface of the film sheet is attached to the connection portion of the frame.

10. The device as claimed in claim 1, wherein the closed container further includes a loading base; one side of the loading base is disposed with a receiving slot for mounting the closed container while the other side is set with a connection part being connected to the first end surface of the film sheet; a shaft is projecting from a bottom surface of the receiving slot while a shaft base correspondingly and moveably connected to the shaft is arranged at the closed container; after the loading base being connected to the closed container by the shaft assembled with the shaft base, the closed container is rotated around the shaft in relative to the loading base.

11. The device as claimed in claim 1, wherein a surface of the side of the closed container with the display part is further arranged with a convex portion; the convex portion includes a convex curved surface.

12. The device as claimed in claim 1, wherein a bottom of the closed container is disposed with a lighting unit; the lighting unit having a housing and at least one lighting member; the housing is fixed on the bottom of the closed container and the lighting member is mounted in the housing; the lighting member is light emitting diode (LED).

13. (canceled)

14. The device as claimed in claim 1, wherein the liquid ornament is selected from the group consisting of a glitter powder ornament, a floating ornament with air bubbles, a sand picture ornament, a cloudy liquid ornament, an ornament with a floating object in a double liquid system, a liquid hourglass ornament, a swinging ornament in a double liquid system, an ornament ejected by liquid, a liquid ornament that changes color during rotation, a liquid-type ornament with slightly transitions, and a water wheel ornament.
